(19) United States
(12) Patent Application Publication
(10) Pub. No.: US 2012/0282054 A1
(43) Pub. Date: Nov. 8, 2012

(54) MULTIPLY INDEXABLE CUTTING INSERT FOR A DRILLING TOOL

(76) Inventors: Horst Manfred Jager, Nurnberg (DE); Thilo Muller, Erlangen (DE)

(21) Appl. No.: 13/504,612

(22) PCT Filed: Oct. 12, 2010
(86) PCT No.: PCT/EP10/06223

§ 371 Date: Jul. 24, 2012

(30) Foreign Application Priority Data
Oct. 28, 2009 (DE) 10 2009 051 073.7

(51) Int. Cl. B23B 27/16; B23B 51/02

(52) U.S. Cl. 408/200; 407/113; 407/114

(57) ABSTRACT

A multiply indexable cutting insert for a drilling tool includes a body defined by two plane-parallel outside faces disposed perpendicular to an insert axis. Each outside face includes a plurality of edges defining a substantially triangular outer contour. Each edge includes a respective main cutting edge extending substantially over the entire length of the respective edge. The body has a rotational symmetry in respect of a 120° rotation about the insert axis and a rotational symmetry in respect of a 180° rotation transversely in relation to the insert axis.

### BACKGROUND OF THE INVENTION

The invention relates to a multiply indexable cutting insert for a drilling tool according to the preamble of claim 1. The invention furthermore relates to a drilling tool realized to receive such a cutting insert, and to the combination of the drilling tool with the cutting insert. Finally, the invention also relates to the use of the cutting insert in the drilling tool.

In the case of drilling tools, multiply indexable cutting inserts, at least in an “outer cutting” position, in which the respective cutting insert cuts as far as the outer periphery of the drilling tool, are usually used in a “vertical” orientation in relation to the tool axis, namely in such a way that the insert plane of the cutting insert is oriented approximately parallelwise in relation to the tool axis. A corresponding drilling tool is known, for example, from EP 0 841 115 A1. In order to ensure the cutting-insert clearance necessary for the drilling operation, cutting inserts used hitherto in drilling tools are predominantly those ground only on one side, i.e. having only one main cutting edge per lateral face. Such cutting inserts, however—in the case of a triangular or rectangular cross section—have three or four main cutting edges that can be used alternately. For example, a cutting insert known from EP 0 841 115 A1 has only two main cutting edges.

Differing from this, EP 1 749 602 A2 discloses a (multiply indexable) cutting insert of the generic type that has six main cutting edges. This cutting insert is designed for use in an associated drilling tool, in which the cutting insert can be inserted, on the one hand, in an outer receiver and, on the other hand, in an inner receiver. In the outer receiver, by which the cutting insert is held in an outer cutting position, the cutting insert is again, as usual, aligned vertically in relation to the tool axis. By contrast, in the inner receiver, in which the cutting insert is held in an “inner cutting” position, i.e. at a distance from the tool outer periphery, the cutting insert is aligned “horizontally” in relation to the tool axis, such that its insert plane is oriented approximately perpendicularly relative to the tool axis. The known cutting insert is realized so as to be non-symmetrical in the direction of the insert axis and, in particular, in this case, has main cutting edges of differing configurations on its two outside faces. In this case, respectively one of these outside faces is provided as a bearing contact surface at the base of a particular, associated receiver. Thus, the known cutting insert is intended to be inserted, with only a first outside face foremost, into the outer receiver. In this orientation, the cutting insert can be indexed twice—namely, turned by 120° about its insert axis in each case—the three main cutting edges opposite the first outside face becoming worn. Then, the known cutting insert is intended to be transferred from the outer receiver into the inner receiver. For this purpose, the cutting insert is indexed transversely relative to the insert axis and accordingly inserted, with the second outside face foremost, into the second receiver. In this position, the cutting insert can be indexed again twice, by 120° in each case, about its insert axis, until the remaining three main cutting edges have also become worn.

Thus, in each of the two receivers of the drilling tool, the known cutting insert has only a triple usage in each case, i.e. it provides only three main cutting edges for indexing in each case.

For use in milling or turning tools, on the other hand, there are known from DE 1 232 436 A, WO 2007/149035 A1 or WO 2009/075633 A1 multiply indexable cutting inserts wherein, in each case, each edge of both outside faces is provided with a main cutting edge. These cutting inserts are distinguished by a particularly high multiple usage. Thus, on these cutting inserts, six main cutting edges can be provided in the case of a triangular insert cross section, and even eight main cutting edges can be provided in the case of a quadrangular insert cross section. These cutting inserts, however, are not suitable for use in a conventional drilling tool, in particular for use in an outer cutting position.

### OBJECT OF THE INVENTION

The invention is based on the object of specifying a multiply indexable cutting insert, having a particularly high multiple usage, designed and especially suitable for use in a drilling tool. The invention is additionally based on the object of specifying a drilling tool that—fitted with this indexable cutting insert—can be operated in a particularly effective manner.

### ACHIEVEMENT OF THE OBJECT

In respect of the (multiply indexable) cutting insert, the object is achieved, according to the invention, by the features of claim 1. In respect of the drilling tool, the above object is achieved, according to the invention, by the features of claim 6. Optional configurations and developments of the invention are given by the dependent claims, the description that follows and by the figures.

The cutting insert according to the invention has two plane-parallel outside faces that are perpendicular to an insert axis and that each have a substantially triangular outer contour. Realized at each edge of each of the two outside faces there is a respective main cutting edge. Thus, in total, the cutting insert comprises six main cutting edges, each of these main cutting edges extending at least substantially over the entire edge length of the cutting insert. According to the invention, in this case the cutting insert is realized so as to be both rotationally symmetrical in respect of a 120° rotation about the insert axis and rotationally symmetrical in respect of a 180° rotation transversely in relation to the insert axis, i.e. in respect of a 180° rotation about a rotational axis perpendicular to the insert axis. Owing to these symmetry properties, the cutting insert can thus be exactly mapped to itself six times. In other words, there are six differing orientations of the cutting insert, which, however, are geometrically indistinguishable from each other.

The drilling tool according to the invention has at least one first receiver for a cutting insert of the type described above. This first receiver comprises a substantially triangular main bearing contact surface, which is designed as a counter-bearing, or counter bearing contact surface, for one of the outside faces of the cutting insert. The receiver is positioned in respect of the drilling tool in such a way that, roughly, its main bearing contact surface is aligned approximately perpendicularly, namely at an angle of between 90° and approximately 60°, in relation to a tool axis and, in the region of one of its corners, extends directly as far as the tool outer periphery. In other words, the first receiver is realized such that the cutting insert intended to be disposed therein is held by it in a horizontal and outer cutting position.

In principle, it is possible for the drilling tool, particularly in the case of small-dimension designs, to have only a single receiver for the cutting insert. Preferably, however, a plurality of receivers, in particular two receivers, are provided on the drilling tool, into each of which receivers a cutting insert of the type described above can be inserted. Of these receivers, all can be disposed for the outer cutting position of the cutting insert. In this case, the drilling tool thus comprises a plurality of “first” receivers in the sense of the above designs. Preferably in this case, between the receivers the drilling tool comprises a central pilot, the main cutting edges of which machine an inner region of the bore.

In an alternative embodiment, on the other hand, the drilling tool comprises, in addition to the “first” receiver, a “second” receiver for a cutting insert of the type described above, this second receiver being offset radially inward relative to the first receiver, and thus being realized for the inner cutting position of the cutting insert. Preferably, this second receiver likewise is of a shape that substantially complements the cutting insert, in particular, again, a substantially triangular main bearing contact surface, which, again, is designed as a counter-bearing or counter bearing contact surface in relation to an outside face of the cutting insert.

The symmetry properties of the cutting insert that are described above enable the cutting insert to be inserted in six differing orientations into the same receiver, and thus, in particular, enable all six main cutting edges of the cutting insert to be used already in the outer cutting position. The use of the cutting insert, provided with main cutting edges on both end faces, in the outer cutting position of a drill tool is in this case made possible, or at least appropriate, by the idea of mounting the cutting insert not vertically in this case—as is usual—but horizontally. The horizontal positioning in an outer cutting position is made possible, in turn, by the triangular shape of the cutting insert.

Insofar as the drilling tool has a “second” receiver, in the sense of the above definition, in addition to the “first” receiver, the cutting insert realized according to the invention can even be used twelve times. This is because, as is known, the respectively active main cutting edge of the cutting insert, when in the outer cutting position, becomes worn principally in the outer corner region, while the main cutting edges in an inner region would be usable for a significantly longer period of time. In the inner cutting position, on the other hand, these outer corner regions are subjected only to comparatively little load. The cutting insert used first in the outer cutting position can therefore continue to be used, again six times, in the inner cutting position, after all six outer corner regions have become worn.

“Outer cutting” in this case again denotes a position of the cutting insert in which the latter cuts as far as the tool outer periphery. In contrast to this, the cutting insert in the “inner cutting” position is at a distance everywhere from the tool outer periphery.

“Horizontal” in this case again denotes a position of the cutting insert in which the insert axis is aligned approximately parallelwise in relation to the tool axis, and the insert plane is aligned approximately perpendicularly in relation to the tool axis. In contrast to this, “vertical” in the following again denotes a position of the cutting insert in which the insert axis is aligned approximately perpendicularly in relation to the tool axis, and the insert plane is aligned approximately parallelwise in relation to the tool axis.

The specifications “approximately triangular” or “substantially triangular”, relating to the outside faces of the cutting insert or to the main bearing contact surfaces of the first and the second receiver, are to be understood as rough specifications. In the region of the corners, in particular, the outside faces of the cutting insert can deviate from an exact triangular shape within the scope of the invention. Thus, in the region of the corners, the outside faces are even preferably “cut off” or rounded off by chamfers. Further, within the scope of the invention, the main cutting edges can have a slight curvature. The main bearing contact surface of the first or second receiver is “substantially triangular”, in the sense of this application, whenever the corresponding cutting insert can be inserted therein in such a way that the cutting insert is received in the receiver in a form-fit manner and so as to be non-rotatable about the insert axis. Within the scope of the invention, deviations from an exact triangular shape can occur in the case of the main bearing contact surface, in particular, again, in the region of the corners. In particular, preferably, individual corners of the “substantially triangular” main bearing contact surface are cut off or hollowed out.

Correspondingly, the specifications “approximately” and “substantially” are also to be understood in any other context as an indication that the specification respectively associated therewith is a rough specification in the context of the invention, i.e. that it is not exact fulfillment of the respective specification that matters. In particular, the main bearing contact surface of the first receiver that is oriented “substantially” perpendicularly in relation to the tool axis is preferably not aligned exactly perpendicularly in relation to the tool axis, but is inclined relative to the normal to the tool axis. The angle of inclination in this case is expediently dimensioned at between 1° and 30°, preferably between 2° and 8°, and in particular approximately 5°.

The cutting insert is preferably realized in such a way that an acute angle is formed between each outside face and an adjoining region of the lateral faces that join the outside faces. As a result, each of the six main cutting edges has a wedge angle of less than 90°.

For this purpose, in a preferred design the cutting insert is composed of two like partial bodies, which each have the shape of a truncated pyramid having a triangular base surface, the base in each case being constituted by one of the outside faces. The two truncated-pyramid shaped partial bodies are in this case set directly or indirectly against each other on the top side, i.e. via the respectively smaller face. In the case of this embodiment, therefore—insofar as the partial bodies are set directly against each other—a flute that tapers in the center plane of the cutting insert is realized in each of the three lateral faces. The term “partial body” in this case is to be understood in a purely geometric sense. Irrespective of this wording, the cutting insert is preferably a single-piece item.

Differing from this, in an alternative embodiment of the cutting insert according to the invention, made in each of the three outside faces, respectively, there are two parallel chip forming flutes, which are separated by a central web, one of these chip forming flutes in each case adjoining a corresponding outside face for the purpose of realizing the acute wedge angle.

In a preferred development of the cutting insert, a recess, i.e. cavity, that is centered in respect of the insert axis is provided in each outside face. As an alternative to a single recess, a structure constituted by a plurality of recesses can also be provided in each end face. Owing to the symmetry properties of the cutting insert that are described above, even the (single) recess must be configured symmetrically in respect of a 120° rotation about the insert axis. In the case of a plurality of recesses per outside face, these must be distributed in a correspondingly symmetrical manner around the insert axis.

These recesses are intended to act in combination with one or more projections, shaped and disposed so as to be complementary, in the main bearing contact surface of the (first or second) receiver of an associated design of the drilling tool. The recesses and projections in this case are matched to each other in such a way that they mesh into each other in a form-fit manner, and thereby fix the cutting insert transversely in relation to the plane of the outside faces, or in relation to the plane of the main bearing contact surface. Insofar as the cutting insert has a central bushing—as is usual—for screwing the cutting insert in the receiver, the said recess is dimensioned in such a way that it projects radially over the diameter of the bore. The recesses and the corresponding projections cause at least a portion of the transverse forces acting upon the cutting insert during operation to be introduced into the drilling tool. The side walls of the receiver and the screw connection that may be provided are relieved of load as a result. This is of importance for the first receiver, in particular, whose outside wall necessarily is comparatively thin, owing to the fact that this receiver is disposed close to the periphery, such that a particularly high material load is to be expected here, resulting from the action of transverse forces. The recesses and the corresponding projections therefore significantly improve the load capacity of the drilling tool and effectively inhibit a tool breakage in the event of overload.

If only one, central recess is provided in each outside face of the cutting insert, this recess preferably has a non-round cross section, having a 120° rotational symmetry in respect of a rotation about the insert axis. In this design, the recess has, for example, the contour of an equilateral triangle, or of a star. Owing to the non-round cross section, the form-fit constituted between the recess, or each recess, and the projection of the main bearing contact surface, again of complementary configuration in each case, causes the cutting insert to be held in the receiver in a rotationally fixed manner. As a result of this, the tangential forces that may be acting upon the cutting disk are also introduced, at least partially, into the drilling tool via the projections. As a result, in turn, the side walls of the receiver are relieved of load. In principle, however, the recess and the corresponding projection can also have a round cross section.

In an expedient embodiment of the drilling tool, the second receiver is realized, just like the first receiver, to hold the cutting insert in a horizontal position. Accordingly, in this embodiment, the main bearing contact surface of the second receiver is again aligned substantially perpendicularly in relation to the tool axis. In an alternative embodiment, by contrast, the cutting insert is intended to be fixed vertically in the second receiver. In this case, the main bearing contact surface of the second receiver is disposed substantially parallelwise in relation to the shank axis. In this case, also, the terms “substantially perpendicular” and “substantially parallelwise” are to be understood as rough specifications, which allow a slight inclination of the main bearing contact surface relative to the shank axis, or to the normal to the latter.

In a comparatively simple realization of the drilling tool, the projection, or each projection, in the main bearing contact surface of the first or second receiver is realized so as to be integral with the wall of the associated receiver. In a particularly advantageous variant of the drilling tool, on the other hand, the projection, or each projection, is part of a separate intermediate piece, which can be inserted, approximately in the manner of a shim, between the main bearing contact surface and the cutting insert. To enable transverse forces and, possibly, tangential forces to be transferred from the cutting insert into the drilling tool, the intermediate piece and the main bearing contact surface are again configured in such a way that they mesh into each other in a form-fit manner.

The realization of the projection, or each projection, on the separate intermediate piece has the advantage, in particular, that the intermediate piece can be produced from a material that differs from that of the rest of the drilling tool. Expediently in this case, the intermediate piece is made of a harder material than the main bearing contact surface, in particular so as to achieve a particularly high wear resistance. The separate intermediate piece has the advantage, in particular, that it can be easily exchanged when worn, while the remaining component parts of the drilling tool can continue to be used. The intermediate piece additionally has the positive side effect that it protects the receiver against erosion by cooling liquid and chip abrasion. For this purpose, in an expedient embodiment it is dimensioned in such a way that, when in the mounted state, it closes, via a side wall, approximately flush with the wall of a chip flute.

The above object is further achieved by a drilling tool of the type described above, into whose receiver or receivers a (respective) cutting insert of the type described above is inserted. In other words, the above object is also achieved through the use of a cutting insert of the type described above as an insert in a drilling tool of the type described above.

### DESCRIPTION OF THE FIGURES

Exemplary embodiments of the invention are described more fully in the following with reference to a drawing, wherein:

FIG. 1 shows a perspective representation of a multiply indexable cutting insert,

FIG. 2 shows a perspective representation of a drilling tool having two receivers, into each of which the cutting insert according to FIG. 1 can be inserted,

FIG. 3 shows a perspective representation of the drilling tool according to FIG. 2, in an orientation rotated in relation thereto,

FIG. 4 shows, in a representation according to FIG. 3, the drilling tool according to FIG. 2 having two cutting inserts according to FIG. 1 inserted in the receivers,

FIG. 5 shows, in a representation according to FIG. 3, the drilling tool according to FIG. 2 having inserted cutting inserts, in an embodiment differing from that of FIG. 1,

FIG. 6 shows, in a representation according to FIG. 3, a modified embodiment of the drilling tool having two inserted cutting inserts according to FIG. 5,

FIG. 7 shows, in a representation according to FIG. 2, a further embodiment of the drilling tool,

FIG. 8 shows, in a representation according to FIG. 3, a further embodiment of the drilling tool having inserted cutting inserts according to FIG. 5, and

FIG. 9 shows a schematic representation of the cutting insert according to FIG. 1, with various specifications for positioning of the same in respect of the drilling tool.

In all figures, parts and quantities that correspond to each other are in each case denoted by the same references.

### DESCRIPTION OF THE EXEMPLARY EMBODIMENT

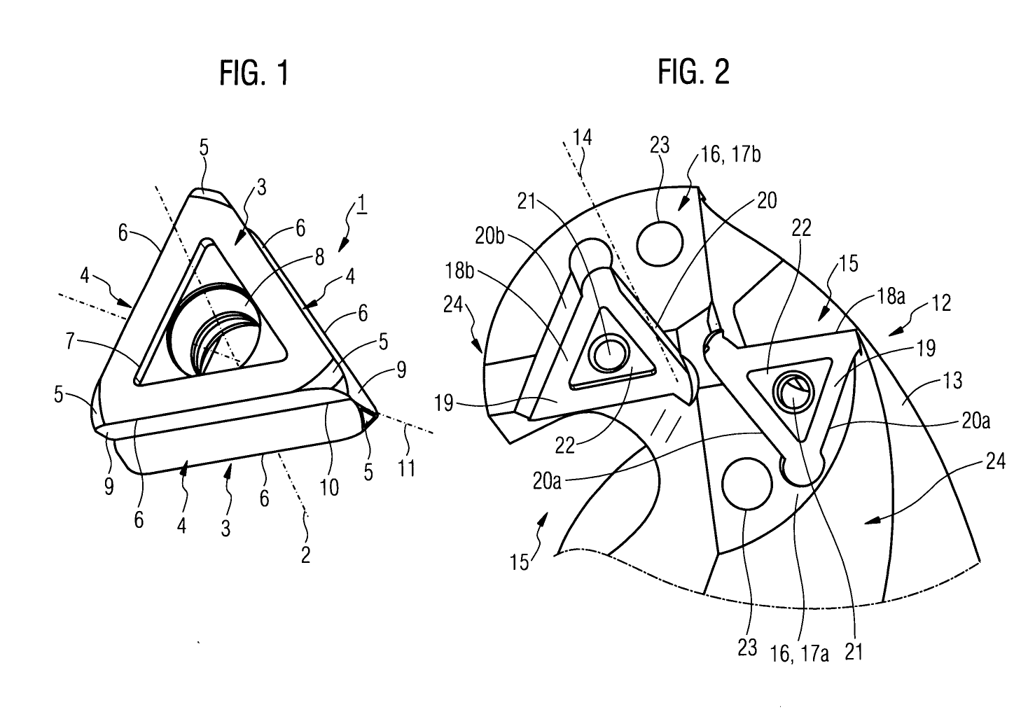

The (multiply indexable) cutting insert 1 represented in FIG. 1 has a cross section approximately in the shape of an equilateral triangle, transversely in relation to an insert axis 2. As viewed in the direction of the insert axis 2, the cutting insert 1 is delimited by two outside faces 3, which are connected by three lateral faces 4.

Each of the two outside faces 3, in turn, has approximately the shape of an equilateral triangle, but with the corners of the triangle shape “cut off” or rounded out by chamfers 5. The edges that constitute the transition from the outside faces 3 to the surrounding lateral faces 4 are realized as main cutting edges 6 over the entire edge length. Accordingly, the cutting insert 1 comprises six main cutting edges 6. Realized at the lateral edges of the cutting insert 1 that join each two lateral faces 4 there is a secondary cutting edge that corresponds, respectively, to each of the main cutting edges 6. On the inside, each outside face 3 is provided with a recess 7 that is centered in respect of the insert axis 2. The recess 7 has the shape of an equilateral triangle aligned in the same direction as the respective outside face 3.

Further, a central bore 8 passes through the cutting insert 1, coaxially in relation to the insert axis 2. In this case, the two openings of the bore 8 are each inscribed in the respective recess 7, i.e. they are tangent on all three sides to the walls of the recesses 7.

Overall, the cutting insert 1 has approximately the shape of a body composed of two partial bodies 9, the partial bodies having the shape of truncated pyramids having a triangular base, and being set top to top directly against each other, i.e. via the respectively smaller face. Each of the lateral faces 4 therefore consists of respectively two partial faces, which join each other at an obtuse angle along the center plane 10 of the cutting insert 10. Owing to the truncated pyramid shape of the partial bodies 9, an acute angle is formed in each case between each outside face 3 and respectively adjoining partial faces of the lateral faces 4. As a result, each cutting edge 6 has a wedge angle of less than 90°.

In the exemplary embodiment according to FIG. 1, the two outside faces 3 are in alignment, such that each two main cutting edges 6 delimiting the same lateral face 4 run parallelwise. Differing from this, however, the two outside faces 3 can also be rotated slightly relative to each other about the insert axis 2.

In each case, however, the cutting insert 1 is realized so as to be symmetrical in respect of a 120° rotation about the insert axis 2. In addition, the cutting insert 1 is realized so as to be symmetrical in respect of a 180° rotation about a rotational axis 11 perpendicular to the insert axis 2.

In the represented exemplary embodiment of the cutting insert 1, the rotational axis 11 runs, inside the center plane 10, through a corner (any corner) of the cutting insert 1 and through the point of intersection of the insert axis 2 with the center plane 10.

Owing to the described symmetry properties, the cutting insert 1 can be mapped to itself six times. In other words, in addition to the orientation of the cutting insert 1 represented in FIG. 1, five further orientations exist, which are geometrically indistinguishable from the representation selected in FIG. 1.

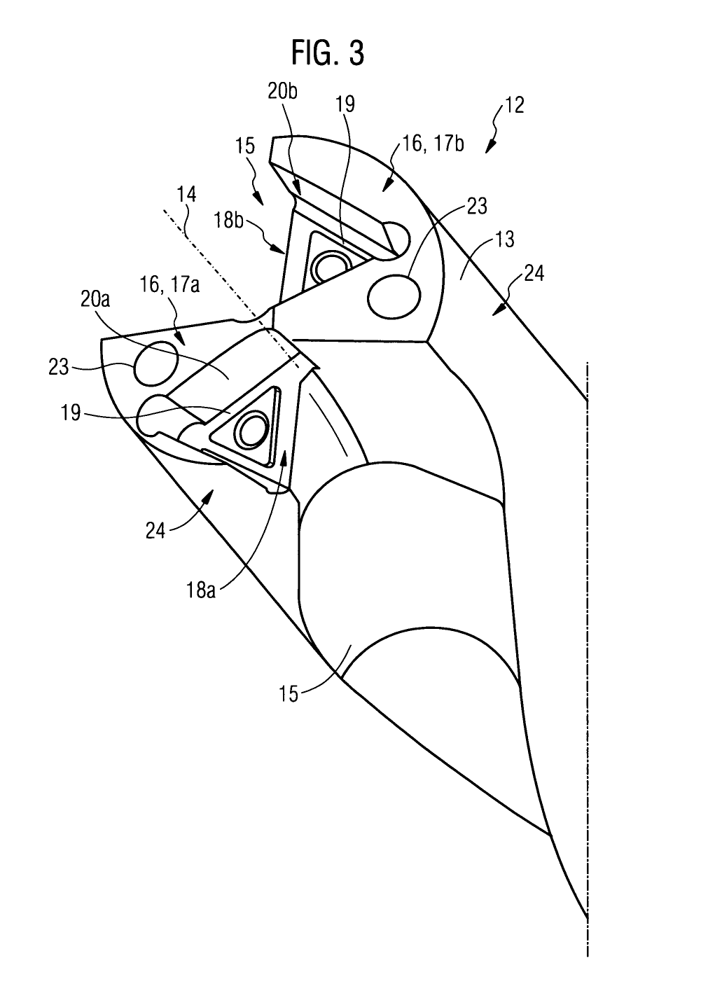

The drilling tool 12 represented in FIGS. 2 and 3 comprises a shank 13, which, in a rough approximation, is cylindrical and in whose circumferential surface there are made two helical chip flutes 15 that extend diametrically in respect of a tool axis 14. FIGS. 2 and 3 show a portion of a head region of the shank 13, which head region constitutes the actual working tip of the drilling tool 12.

As can be seen from FIGS. 2 and 3, the chip flutes 15 open in a head-end outside face 16 and divide the latter into two sub-sections, designated in the following as flanks 17a and 17b. Made in each of the flanks 17a and 17b in this case there is a receiver 18a and 18b, into each of which a cutting insert 1 can be inserted. In the embodiment according to FIGS. 2 and 3, the drilling tool 12 itself does not have any cutting edges. Rather, it serves merely as a holder for the cutting inserts 1.

Each of the receivers 18a and 18b has a main bearing contact surface 19, which, in respect of its shape, corresponds to the outside faces 3 and is therefore realized approximately in the shape of an equilateral triangle, and which serves as a counter-bearing or counter bearing contact surface for one of the outside faces 3. The main bearing contact surface 19 of each receiver 18a, 18b is in each case surrounded on two sides by side walls 20a and 20b, respectively. Towards the third side, each of the receivers 18a and 18b is open towards the—in the intended direction of rotation of the drilling tool 12—respectively leading chip flute 15.

The respective main bearing contact surface 19 of the receivers 18a and 18b is provided in its center with a respective threaded bore 21, which corresponds with the through-bore 8 of the associated cutting insert 1. The threaded bore 21 is in each case surrounded by a projection 22 that forms an equilateral triangle. Each of the projections 22 in this case is realized so as to complement the recesses 7 of the cutting insert 1, and is intended to act in combination with these recesses 7 to constitute a form-fit.

It can further be seen from FIGS. 2 and 3 that the inner corner and the trailing corner of each receiver 18a and 18b are hollowed out, in order to make free space for the corresponding corner regions of the cutting insert 1 to be inserted. Further, FIGS. 2 and 3 show two openings of channels 23 for coolant and/or lubricant, one of these channels 23 in each case opening, behind one of the receivers 18a and 18b, into the respectively associated flank 17a and 17b, respectively.

In the exemplary embodiment according to FIGS. 2 and 3, the two receivers 18a and 18b are disposed in the outside face 16 so as to be radially offset in relation to each other. The first receiver 18a is disposed in such a way that its outer corner reaches directly as far as the outer periphery 24 of the shank (also designated, in a generalized manner, as the tool outer periphery). The receiver 18a thus serves for outer-cutting positioning of the cutting insert 1. The second receiver 18b, by contrast, is disposed in the outside face 16 in such a way that its outer corner is at a distance from the outer periphery 24. This receiver 18b therefore serves for inner-cutting positioning of the cutting insert 1. In the exemplary embodiment according to FIG. 2, both receivers 18a and 18b are disposed in such a way that the cutting insert 1 is positioned as intended in a horizontal position in respect of the tool axis 14. Accordingly, the main bearing contact surfaces 19 of both receivers 18a and 18b are aligned approximately perpendicularly in relation to the tool axis 14.

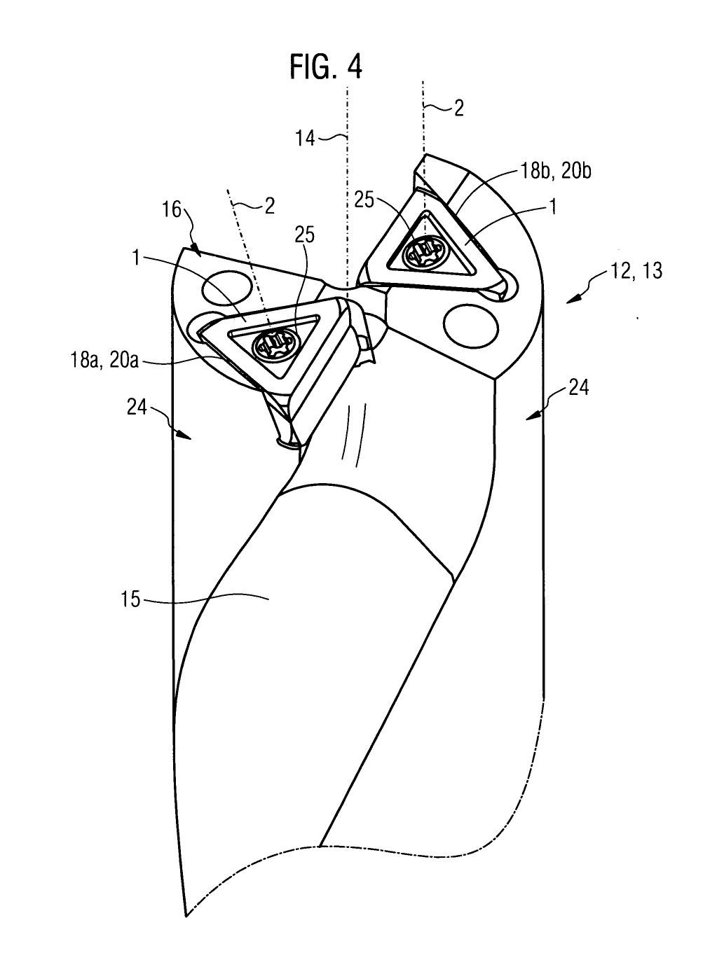

FIG. 4 shows the drilling tool 12 with the cutting inserts 1, horizontal in respect of the tool axis 14, inserted in the receivers 18a and 18b. It can be seen in this representation, in particular, that each of the cutting inserts 1 lies in a form-fit manner in the associated receiver 18a and 18b, respectively, the side walls 20a and 20b of the receivers 18a and 18b, respectively, each closely flanking two lateral faces 4. Irrespective of the fact that each cutting insert 1 bears with two-sided contact on the adjoining side walls 20a and 20b, the forces acting upon the cutting inserts 1, transversely and tangentially relative to the respective insert axis 2, are introduced into the drilling tool 12 principally via a form fit that is constituted in each case between a recess 7 of each cutting insert 1 and the projection 22 engaging therein. The side walls 20a and 20b of the receivers 18a and 18b, respectively, are relieved of load as a result. This is of importance, in particular, for the outer receiver 18a, especially—as can be seen, in particular, from FIG. 4—whose outer side wall 20a has only very little thickness of material, owing to the proximity to the outer periphery 24.

FIG. 4 additionally shows two tightening screws 25, which are passed through the through-bore 8 of an associated cutting insert 1 and are screwed in the threaded bore 21 of the associated receiver 18a or 18b, said threaded bore being located behind said through-bore. The cutting inserts 1 are thus clamped by the tightening screws 25 into the respectively associated receiver 18a and 18b.

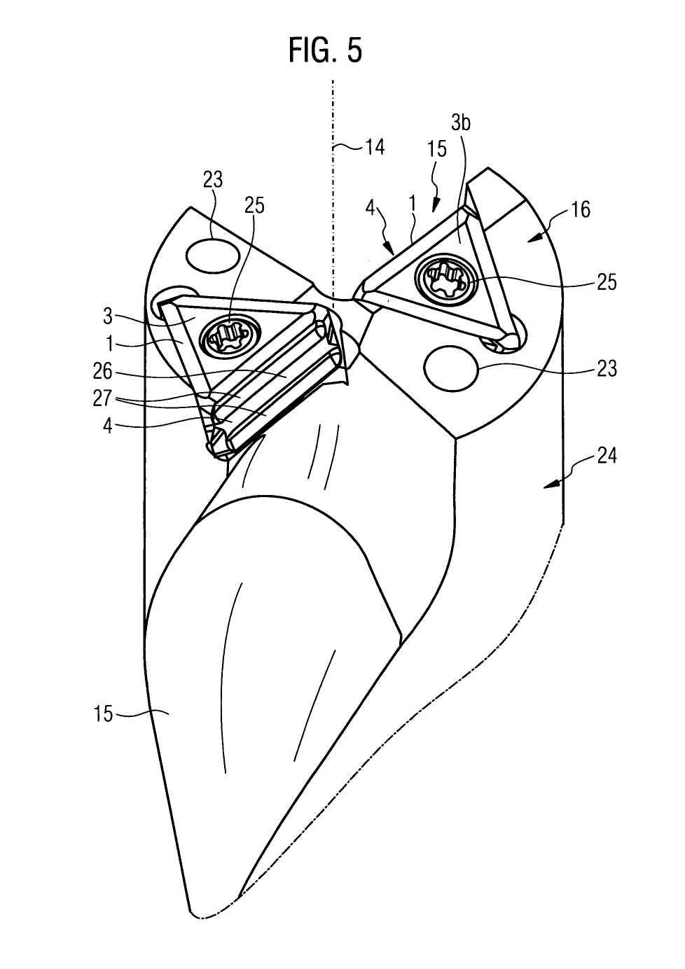

FIG. 5 shows the drilling tool 12 already described in connection with FIGS. 2 to 4, with inserted cutting inserts 1, these cutting inserts 1 here being in an embodiment that differs from that of FIG. 1. The cutting inserts 1 represented in FIG. 5 differ from the embodiment described in connection with FIG. 1 in that, instead of a single flute, two parallel chip forming flutes 27, which are separated by a central web 26, are provided in each lateral face 4. In this case, respectively one of the chip forming flutes 27 adjoins an associated outside face 3. As a result, the main cutting edge 6 formed between each outside face 3 and the respectively adjoining chip forming flute 27 is again realized with an acute wedge angle.

In other respects, the cutting insert 1 represented in FIG. 5 is the same as the embodiment described in connection with FIG. 1. In particular, the outside faces 3 of this cutting insert 1 are likewise optionally provided with recesses 7, as represented in FIG. 1.

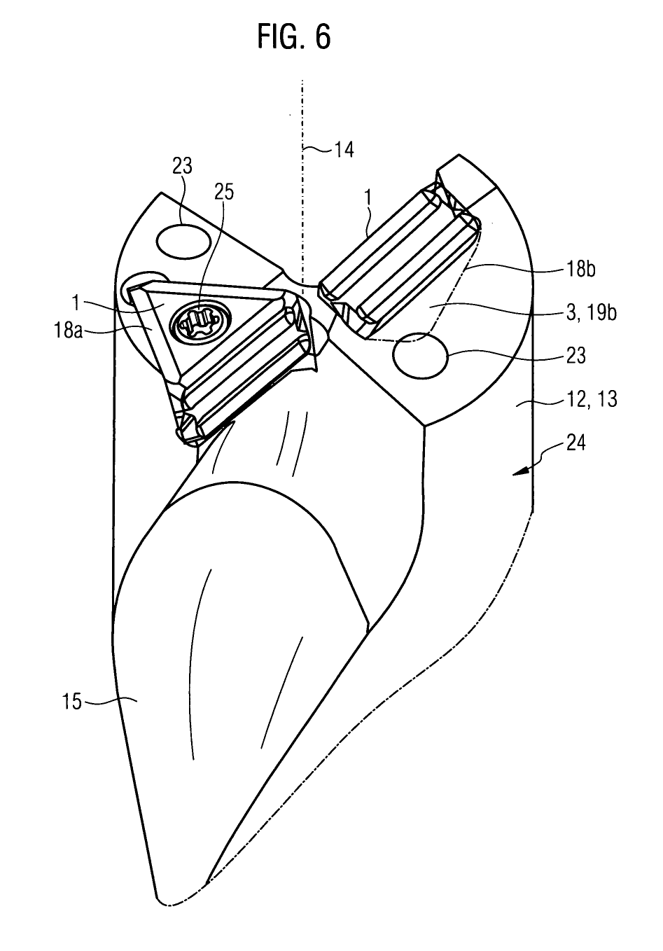

FIG. 6 shows a variant of the drilling tool 12. The latter differs from the embodiment described above substantially in that the second receiver 18b has an alignment tilted by 90° relative to the first receiver 18a and, accordingly, is realized for mounting the cutting insert 1 in a vertical position in respect of the tool axis 14. Here, accordingly, the receiver 18b has a main bearing contact surface 19, which is aligned approximately parallelwise in relation to the tool axis 14 or, more precisely, approximately in an axial-radial orientation. In FIG. 6, the drilling tool 12 is shown exemplarily with inserted cutting inserts 1 of the type represented in FIG. 5.

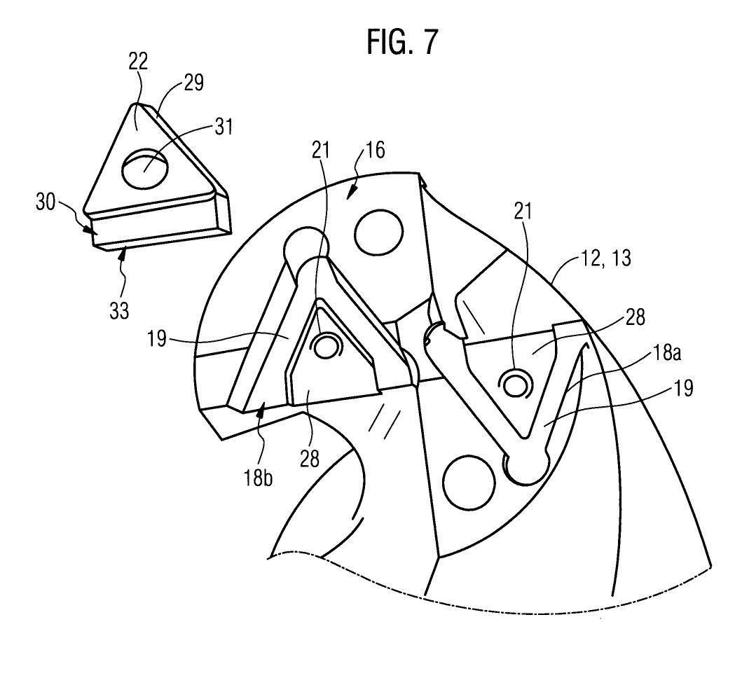

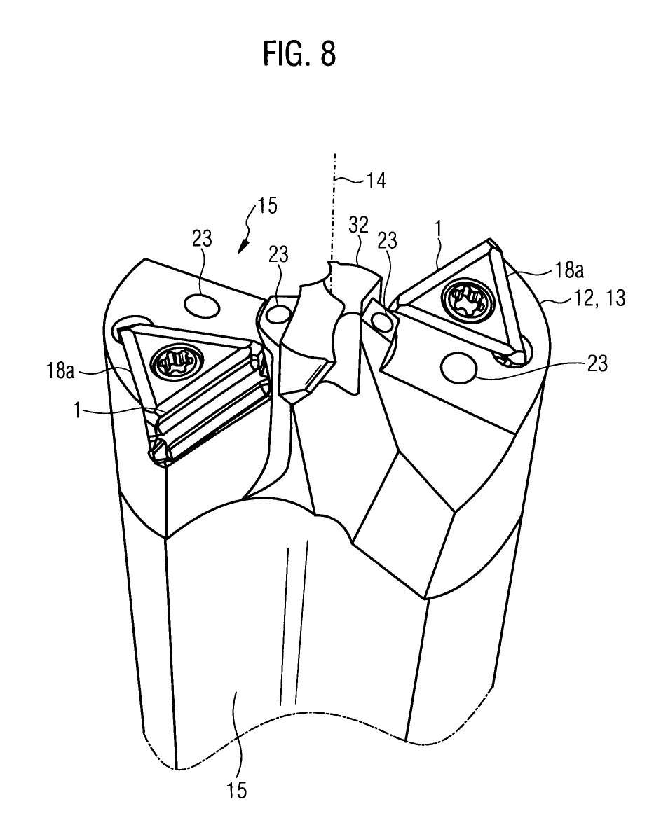

FIG. 7 shows a further embodiment of the drilling tool 12. Unless otherwise described in the following, this third embodiment of the drilling tool 12 is also the same as the embodiment according to FIGS. 2 and 3. Differing from the embodiment of the latter figures, FIG. 7 shows that, instead of the projections 22 in the main bearing contact surfaces 19 of the receivers 18a and 18b, a respective cavity 28 is provided. In this embodiment, the drilling tool 12 additionally comprises two intermediate pieces 29. Each one of the two intermediate pieces 29, which are of like structure, and only one of which is represented in FIG. 7, for reasons of simplicity, is intended to be inserted, in the manner of a shim, between the corresponding main bearing contact surface 19 and the cutting insert 1 to be mounted thereon. Each of the intermediate pieces 29 has a respective back side (facing away in the perspective representation according to FIG. 7), via which the respective intermediate piece 29 can be inserted with a form fit into the respectively corresponding cavity 28. Provided on a front side 30 that is opposite this back side there is the projection 22, again realized so as to complement the recesses 7 of the cutting insert 1. Each intermediate piece 29 additionally has a central bore 31, through which one of the tightening screws 25 can be passed.

When in the mounted state, the intermediate pieces 29, which engage in the cutting insert 1, on the one hand, and in the corresponding cavity 28, on the other hand, thus mediate an indirect form fit between the cutting insert 1 and the receiver 18a or 18b respectively receiving the latter.

Each of the intermediate pieces 29 is dimensioned in such a way that, when in the mounted state, it reaches, by a lateral face 33, as far as the wall of the corresponding chip flute 15, and preferably closes approximately flush with the chip flute wall. The lateral face 33 in this case constitutes a kind of apron that, in the region above the cutting insert 1, protects the chip flute 15 against chip abrasion.

A further embodiment of the drilling tool 12 is again represented in FIG. 8. This embodiment differs from the variants of the drilling tool 12 described above in that, instead of an outer receiver 18a and an inner receiver 18b, two receivers 18a are provided, which are disposed in a radially symmetrical manner in relation to each other and which are both realized for outer-cutting positioning of respectively one cutting insert 1 in a horizontal position in respect of the shank axis 14. Here, provided in a radially inner region between the two receivers 18a, there is a so-called pilot 32, which is provided with its own main and secondary cutting edges. Here, the pilot 32 is represented as an integral constituent part of the shank 13. However, the pilot 32 can also be configured as a separate part that can be connected to the shank 13. The drilling tool 12 according to FIG. 8 differs further from the embodiments described above in that its two chip flutes 15 made diametrically in the circumferential surface of the shank 13 are not helical, or are only slightly helical. In other respects, the drilling tool 12 according to FIG. 8 is the same as the embodiments described above.

All represented embodiments of the drilling tool 12 can be fitted both with the cutting inserts 1 in the embodiment according to FIG. 1 and with the modified cutting inserts 1 in the embodiment according to FIG. 5. In addition, the individual configuration features of the represented drilling tools 12 and cutting inserts 1 can be combined with each other—insofar as possible—in any manner.

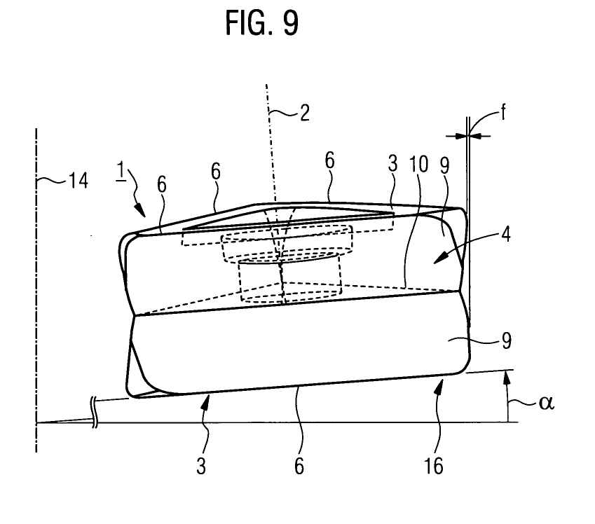

FIG. 9 indicates, in a schematic representation, that the receiver 18a fixes the cutting insert 1, or each cutting insert 1, at least in the outer-cutting position, not exactly perpendicularly in relation to the tool axis 14, but in a position that is slightly inclined in relation to the normal to the tool axis 14. The leading main cutting edge 6 of the cutting insert 1 in this case assumes, relative to the normal to the tool axis 14, a pitch angle a, which, in a preferred dimensioning, is between 2° and 8°, preferably approximately 5°. Because of this oblique position of the cutting insert 1, a sufficient clearance f of the cutting insert 1 is achieved in the region of the outside face 3 that faces away from the outside face 16, and that is therefore not active in cutting.

It can also be seen from FIG. 9 that the cutting insert is also slightly tilted in the tangential direction.

1-14. (canceled)

15. A multiply indexable cutting insert for a drilling tool, the insert comprising:
a body defined by two plane-parallel outside faces disposed perpendicular to an insert axis, each outside face having a plurality of edges defining a substantially triangular outer contour, each edge having a respective main cutting edge extending substantially over the entire length of the respective edge,
wherein the body has a rotational symmetry in respect of a 120° rotation about the insert axis and a rotational symmetry in respect of a 180° rotation transversely in relation to the insert axis.

16. The insert of claim 15 wherein the body comprises two like partial bodies, each partial body in the shape of a truncated pyramid, whose base in each case is constituted by one of the outside faces and which, on the top side of the truncated pyramid, are set directly or indirectly against each other.

17. The insert of claim 15 wherein the body comprises three lateral faces which connect the outside faces, each lateral face including two parallel chip forming flutes separated by a central web, each flute adjoining a corresponding outside face.

18. The insert of claim 15 wherein each outside face comprises a recess that is centered in respect of the insert axis.

19. The insert of claim 15 wherein each outside face comprises a plurality of recesses that are distributed around the insert axis.

20. The insert of claim 18 wherein the recess has a non-round cross section.

21. A drilling tool comprising:
a shank comprising a first receiver structured to receive a first insert as recited in claim 15, the first receiver having a substantially triangular first main bearing contact surface structured for bearing contact on one of the outside faces of the cutting insert, and the first main bearing contact surface being aligned at an angle of between 90° and approximately 60° in relation to a tool axis.

22. The drilling tool of claim 21 wherein the first receiver includes three corner regions, and wherein, in the region of one of the three corner regions, the first receiver extends as far as an outer periphery of the shank.

23. The drilling tool of claim 21 wherein the shank comprises a second receiver structured to receive a second insert, the second receiver being offset radially inward relative to the first receiver.

24. The drilling tool of claim 23 wherein the second receiver is structured to receive a second insert having the same shape as the first insert.

25. The drilling tool of claim 24 wherein the second receiver has a substantially triangular second main bearing contact surface for bearing contact on one of the outside faces of the second insert and wherein the second main bearing contact surface is disposed substantially perpendicular to the tool axis.

26. The drilling tool of claim 21 wherein the first main bearing contact surface comprises a projection structured for form-fit engagement with a corresponding recess of the first cutting insert.

27. The drilling tool of claim 26 wherein the projection is a portion of an intermediate piece that is separate from the first main bearing contact surface and that can be inserted in the first main bearing contact surface in a form-fit manner.

28. The drilling tool of claim 27 wherein the intermediate piece is made of a material that differs from that of the main bearing contact surface.

29. The drilling tool of claim 28 wherein the material from which the intermediate piece is made is harder than the material of the bearing contact surface.

30. The drilling tool of claim 28 wherein the intermediate piece is insertable in the first main bearing contact surface in a manner such that a side wall of the intermediate piece is approximately flush with a wall of a chip flute formed in the shank.

31. A drilling tool comprising:
a shank comprising a first receiver; and
an insert disposed in the first receiver, the insert comprising:
a body defined by two plane-parallel outside faces disposed perpendicular to an insert axis, each outside face having a plurality of edges defining a substantially triangular outer contour, each edge having a respective main cutting edge extending substantially over the entire length of the respective edge, the body having a rotational symmetry in respect of a 120° rotation about the insert axis and a rotational symmetry in respect of a 180° rotation transversely in relation to the insert axis;
wherein the first receiver comprises a substantially triangular first main bearing contact surface bearing contact on one of the outside faces of the cutting insert, and the first main bearing contact surface is aligned at an angle of between 90° and approximately 60° in relation to a tool axis.
